(19) United States
(12) Patent Application Publication
(10) Pub. No.: US 2007/0209991 A1
(43) Pub. Date: Sep. 13, 2007

(54) Plate shifter for filter press

(75) Inventor: Geoffrey D. Kemp, Mississauga (CA)

Correspondence Address: Lipsitz & McAllister, LLC, 755 MAIN STREET, MONROE, CT, 06468, US

(73) Assignee: Komline-Sanderson Ltd., Brampton (CA)

(21) Appl. No.: 11/375,556

(22) Filed: Mar. 13, 2006

(51) Int. Cl. B01D 25/00

(52) U.S. Cl. 210/231; 210/230; 210/323.1

(57) ABSTRACT

A plate shifting apparatus for a filter press having a series of filter plates in a horizontal series can be used to remove filter cake from the plates after a filter operation. The plates are horizontally movable in a longitudinal direction of the press. The apparatus includes a shifter carriage adapted for horizontal movement in the longitudinal direction and a plate shifting assembly mounted on this carriage. The assembly includes a movable endless flexible member that in use extends horizontally in the longitudinal direction and a shifter member, such as a pin, mounted on the flexible member for movement therewith. During use of the apparatus, the assembly can shift each filter plate in the series horizontally from a first filtering position to a second position in order to discharge the filter cake, and this shifting is carried out sequentially starting with a leading filter plate in the series. Each filter plate is moved by the shifter member being moved by the flexible member into engagement with the respective filter plate and then being moved along with the filter plate horizontally.

### BACKGROUND OF THE INVENTION

This invention relates to plate shifting machines and devices for a filter press having a series of filter plates in a horizontal series, these plates being horizontally movable on the press.

A variety of filter presses are known in the filtering industry and such presses have been in use for a number of years. The filtering method used by a filter press is a batch operation that periodically requires the accumulated solids that have been retained on the filter medium to be discharged. These solids which are commonly referred to as filter cake are often sticky in nature and, in such cases, some intervention either of a mechanical nature or by the operator of the machine is required to make sure all of the filter cake is discharged each time.

Also a number of devices and machines have been designed and constructed in the past in order to horizontally shift the filter plates on the filter press for discharge and cleaning purposes and the demand for automatic plate shifters is increasing in the filtering industry. Where the filter cake being generated by the filter press is known to discharge cleanly, the use of an automatic plate shifting mechanism which positively provides plate separation on or in conjunction with the filter press has practical advantages. If two or more plates stick together in a conventional filter press having an automatic plate shifting mechanism, then more than one plate can be transported and the cake between these particular plates will not be discharged. Also, when it is necessary to wash the filter media in place after the filtering step, it is desirable to have a reliable automatic mechanism for moving the filter plates.

Many of the plate shifting mechanisms developed up to the present time are chain driven and these mechanisms can have either reciprocating or continuous chain motion. Some of these known plate shifting mechanisms are operated by means of weighted or spring loaded pawls that engage and disengage with the filter plates during the shifting cycle.

U.S. Pat. No. 4,289,618 which issued Sep. 15, 1981 describes a filter press with a horizontal guide carrier extending in the lengthwise direction of the press. Filter plates are shiftably mounted on the guide carrier and the shifting apparatus is provided for individually displacing the filter plates from a closed side towards an open side of the press. The shifting apparatus has a motor driving a traveling carrier element and filter plate engaging elements are mounted on the carrier element. A monitoring and control device is connected to the motor for controlling the motion of the filter plate engaging elements for controlling the shifting motion of individual plates.

U.S. Pat. No. 4,364,827 issued Dec. 21, 1982 to Envirotech Corporation describes an apparatus for moving filter plates from one end of the filter press to the other end, including carriages which selectively couple to each of the plates and which are driven to slide along the frame members of the press by a hydraulic motor.

### SUMMARY OF THE INVENTION

According to one aspect of the invention, a plate shifting apparatus is provided for a filter press having a series of filter plates in a horizontal series, the filter plates being horizontally movable in a longitudinal direction of the press. The apparatus comprises a shifter carriage adapted for horizontal movement in the longitudinal direction and a plate shifting assembly mounted on the shifter carriage for movement with the carriage in the longitudinal direction. The plate shifting assembly includes a movable endless flexible member, that in use extends horizontally in the longitudinal direction, and a shifter member mounted on the flexible member for movement therewith. During use of this apparatus, the shifting assembly can shift each filter plate in the series horizontally from a first filtering position to a second position in order to discharge filter cake from each filter plate. The shifting is carried out sequentially starting with a leading filter plate in the horizontal series. Each filter plate is shifted by the shifter member being moved by the flexible member into engagement with the respective filter plate and then being moved along with the filter plate by the flexible member horizontally to the second position.

According to another aspect of the present invention, a plate shifting apparatus is provided for a filter press having a series of movable filter plates in a horizontal series and having lateral projections on sides of the filter plates. The apparatus comprises a shifter carriage and a track on which the shifter carriage can be mounted for movement in a horizontal direction, this track being adapted for mounting adjacent to the filter press. This apparatus also includes an anchor mechanism mounted on the shifter carriage and having an anchor member movable between a plate holding position where the anchor member extends between the projections of two of the filter plates in order to hold a second of the filter plates against movement in the horizontal direction and a retracted position which permits horizontal shifting of the anchor mechanism during use of the apparatus. A plate shifting assembly is mounted on the shifter carriage for horizontal movement therewith, this assembly including first and second sprocket wheels rotatably mounted on the carriage and spaced from each other horizontally a predetermined distance corresponding to a desired distance for shifting each filter plate in order to remove filter cake from between adjacent plates and an endless flexible member extending around the two sprocket wheels for movement along first and second horizontal runs. A shifter pin is mounted on the flexible member for movement therewith. During use of this apparatus, the shifter pin is movable to a first position where the shifter pin extends between the same two projections as the anchor member, is then engaged with the handle of the first of the two plates, and is then moved horizontally together with the first plate along the first run by the flexible member to the first sprocket wheel. The shifter pin subsequently is returned along the second run to the second sprocket wheel. This sequence of steps is repeated on the remaining unshifted plates in order to move each of these filter plates towards the first sprocket wheel and up to a location adjacent to the immediately preceding filter plate of the series.

Further features, aspects, and advantages will become apparent from the following detailed description of one embodiment, taken in conjunction with the accompanying drawings.

### BRIEF DESCRIPTION OF THE DRAWINGS

FIG. 1 is an end elevation of a plate shifter apparatus constructed in accordance with the invention, the location of the filter plates indicated by dash lines.

FIG. 2 is a side elevation of the plate shifter apparatus of FIG. 1.

FIG. 3 is an elevational view of the plate shifter apparatus as seen from the position indicated by the III arrow of FIG. 1.

FIG. 3A is an isometric view taken from above but in the general direction of the arrow III from FIG. 1.

FIG. 4 is a plan view of the plate shifter assembly with the drive motor and upper drive train omitted for sake of illustration.

FIG. 5 is a detail end elevational view illustrating the cylinder mechanism and the anchor pin connected thereto in the up position.

FIG. 6 is a detail side elevational view of the cylinder mechanism in the up position.

FIG. 7 is a detail top view of a portion of one drive chain showing a pawl in its up position engaging a shifter pin.

FIG. 8 is a detail side view showing a portion of the drive chain and the shifter pin of FIG. 7, again with the pawl in the up position.

FIG. 9 is a detail top view similar to FIG. 7 showing the pawl in the down position.

FIG. 10 is a detail side view similar to FIG. 8 but showing the pawl in the down position.

FIGS. 11A and 11B are schematic plan and elevational views illustrating filter plates arranged in a series and the plate shifter assembly ready to move into position to collect the first plate.

FIGS. 12A and 12B are schematic plan and elevational views illustrating the plate shifter assembly with its shifter pin rotating around sprocket A into a space between handles of filter plates 1 and 2.

FIGS. 13A and 13B are schematic plan and elevational views illustrating the shifter pin pushing the first filter plate to its furthest extent of travel.

FIGS. 14A and 14B are schematic plan and elevational views illustrating how the shifter carriage is moved a distance equal to the radius of sprocket B.

FIGS. 15A and 15B are schematic plan and elevational views illustrating the shifter pin being rotated past the handle of filter plate 2 and rotating between the handles of the second and third plates.

FIGS. 16A and 16B are schematic plan and elevational views illustrating the position of the plate shifter assembly when the last filter plate in the series has been shifted, the anchor member is retracted and the direction of the shifter drive is about to be reversed.

FIG. 17 is a schematic elevational view illustrating the position and direction of the plate shifter assembly when the shifter pin contacts a raised return pawl in order to move the shifter carriage a distance equal to the distance between the sprocket wheels.

FIGS. 18A and 18B are schematic plan and elevational views showing the position of the plate shifter assembly after it has been moved one full increment equal to the distance between the sprocket wheels.

FIG. 19 is a schematic elevational view illustrating the position of the plate shifter assembly when the shifter pin has been advanced to the position between the handles of the first and second filter plates.

FIGS. 20A and 20B are schematic plan and elevational views illustrating the parked position of the plate shifter assembly when the filter press is still in the open position.

FIGS. 21A and 21B are schematic plan and elevational views illustrating the parked position of the plate shifter assembly after the filter press has been closed (and the filter plates shifted to the left when the press is viewed from one side).

### DETAILED DESCRIPTION OF REPRESENTATIVE EMBODIMENT

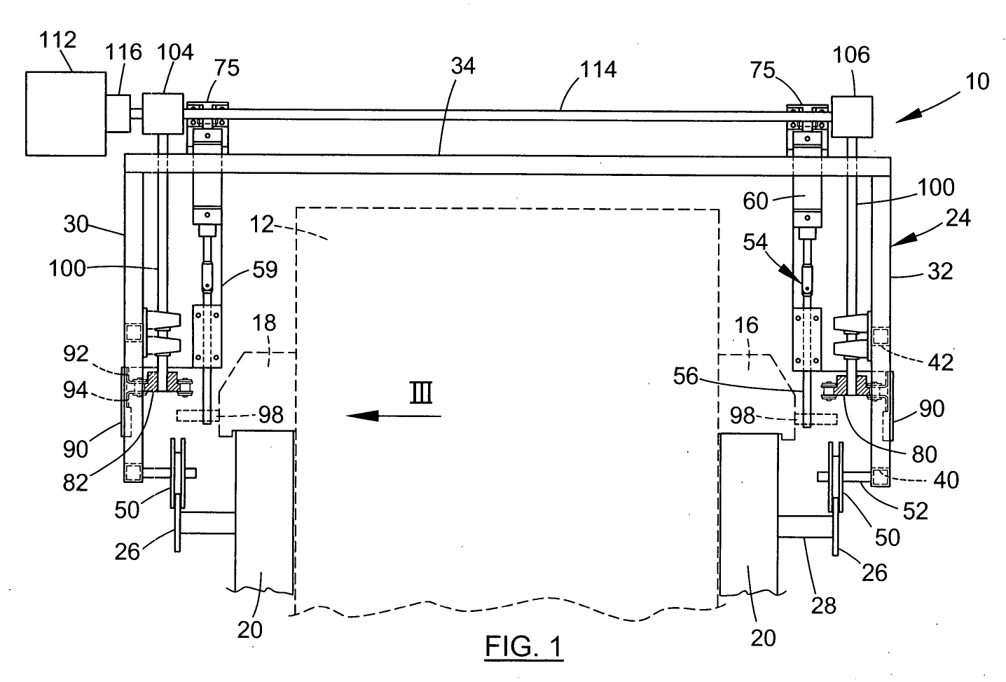

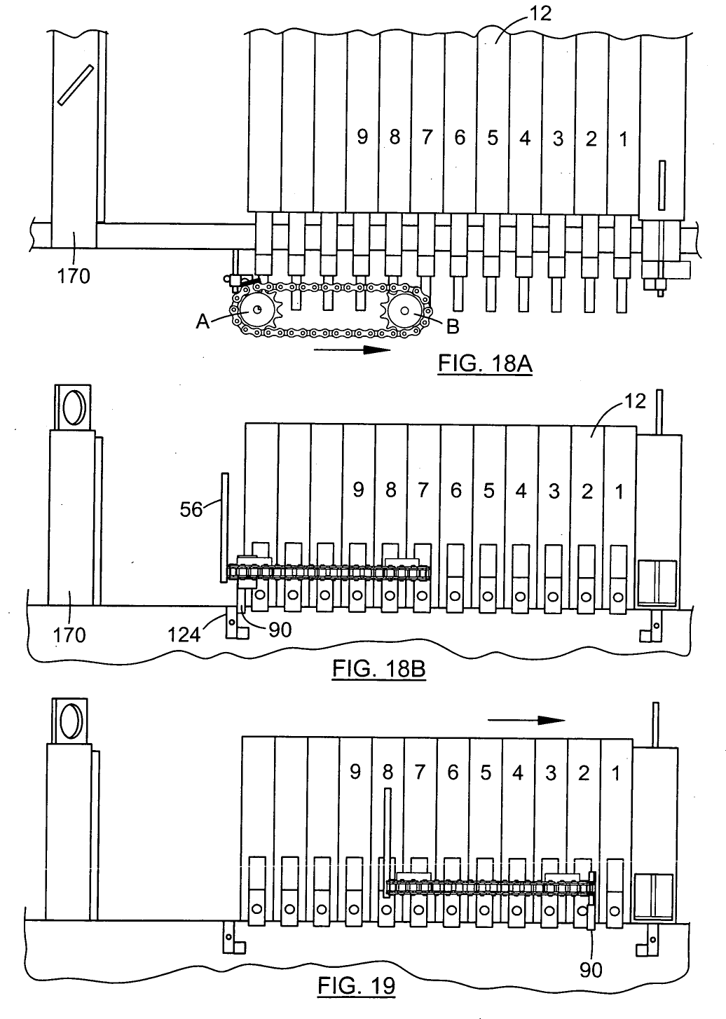

FIGS. 1 to 3 illustrate one embodiment of a plate shifting apparatus 10 constructed in accordance with the invention and constructed for use with a filter press 12 having a series of movable filter plates 14. The filter press, which can be a standard filter press of well known construction is outlined partially in FIG. 1 and is shown only in part in schematic FIGS. 11A to 19. The filter plates are arranges in a horizontal series and it will be appreciated that they are pressed against one another in the filter press in order to carry out a filtering operation. However, in order to discharge filter cake from the filter plates and the filter media, it is necessary to separate these plates in a sequential manner in order to separate each plate from its immediately adjacent filter plate. Each filter plate is provided with handles or projections 16, 18 on opposite sides thereof which support the plate on two parallel longitudinal frame members 20, one on each side of the press. It will be understood by those skilled in the art that a filter press head, the position of which can be fixed, is used to support one end of the frame members 20 while the opposite ends can be mounted on another support. A follower 22 shown schematically in FIGS. 11A to 15B and 18A to 21B is movably mounted on the frame members 20 and can, for example, be provided with rollers which engage the frame members to enable the follower to be moved toward and away from the press head.

The illustrated plate shifting apparatus includes a shifter carriage indicated generally by 24 and a track 26 on which the shifter carriage can be mounted for movement in a horizontal direction, the track being adapted for mounting adjacent to the filter press 12. If desired, the track can be mounted by connecting bars 28 to the frame members 20 of the press. The shifter carriage has two side frame sections 30 and 32 adapted for mounting on opposite sides of the filter press 12 and a top frame arrangement 34 rigidly interconnecting the two side frame sections and constructed to extend over the series of filter plates during use of the apparatus. Each side frame section 30, 32 includes two upright frame members 36, 38 which are connected rigidly together at their bottom ends by horizontal frame member 40. There is also an intermediate, horizontal frame member 42 that connects the frame member 36 and 38 approximately midway along their length. A vertical support plate 44 is mounted on the inside of each frame member 42 and is also connected to the upright frame members. The support plate as well as the various frame members can be welded to one another. The top frame arrangement as shown comprises two horizontal, elongate frame members 46, 48.

Mounted on each of the side frame sections are two rollers 50 which are mounted on short, horizontal shafts 52 and are free to rotate on their respective shafts. Each shaft can be mounted on the frame member 40, but the rollers are spaced apart to provide stability to the shifter carriage and they can be provided with a circumferential groove for engagement with the track. The illustrated track has two rail sections which are adapted for mounting so as to extend horizontally on opposite sides of the filter press. Each rail section can comprise a flat, elongate metal strip arranged in a vertical plane as shown in FIG. 1. The edge of the metal strip fits into the groove in the rollers 50.

An anchor mechanism indicated generally at 54 is mounted on the shifter carriage 24 and has an anchor member 56 between a plate holding position wherein the anchor member extends between the projections or handles of two of the filter plates in order to hold a second of the two plates against movement in the horizontal direction and a retracted position which permits horizontal shifting of the anchor mechanism during use of the apparatus 10. As illustrated, the anchor member is a vertically extending rod member. The anchor mechanism is shown mounted on the shifter carriage in FIGS. 1 to 3 and is shown separately in FIGS. 5 and 6 wherein the anchor pin or rod member is shown in the retracted or up position. The anchor mechanism includes a guide block (UHMW) 58 having a vertical passage for receiving the rod member 56 and a drive cylinder device 60 which can be operated pneumatically. A rectangular, vertical support plate 59 is rigidly mounted on the inside surface of frame members 46 and 36. The guide block 58 is mounted at the bottom end of the plate 59 by means of bolts at 70. A movable drive rod 64 can be extended or retracted by the cylinder device 60. This drive rod is flexibly connected to the top end of rod member 56 by means of shaft connector 61. Each cylinder device 60 is connected to the horizontal frame member 46 by means of a connecting bracket 74 and an angle member 75. Further details concerning the operation of the anchor mechanisms will be provided hereinafter in conjunction with the operation of the plate shifting assembly.

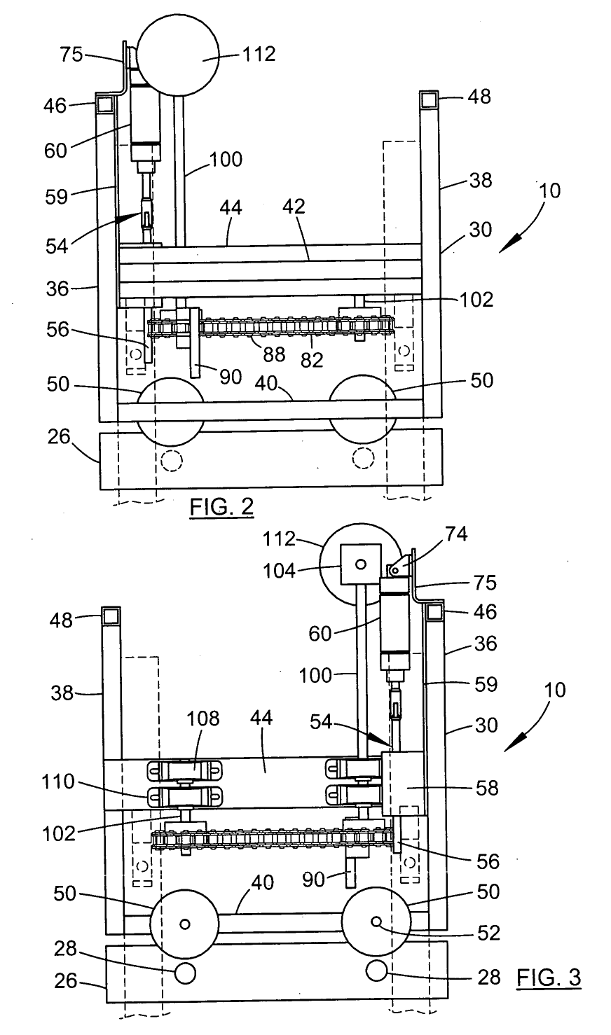

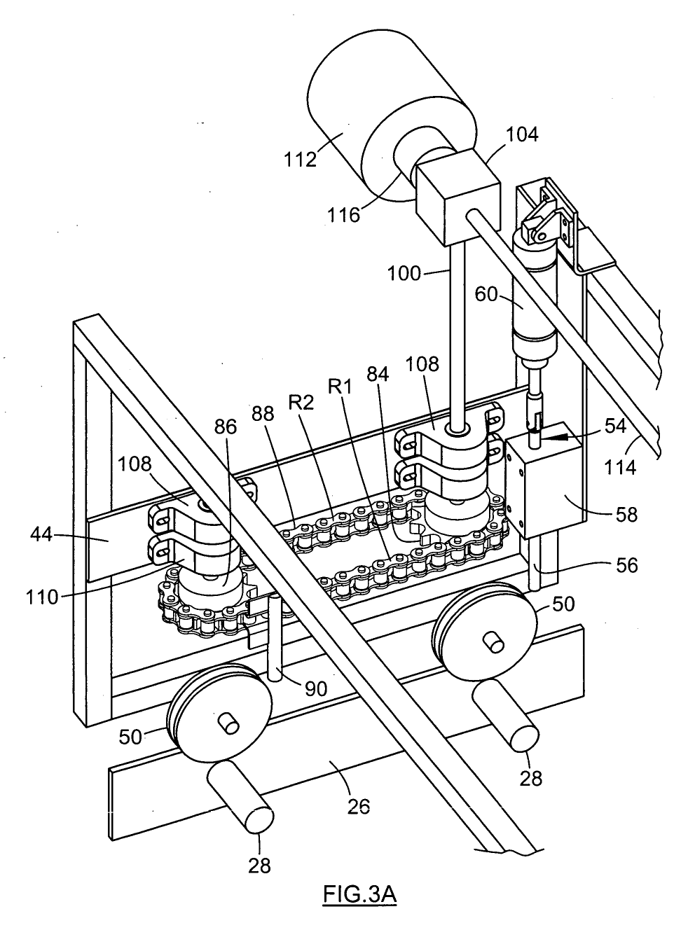

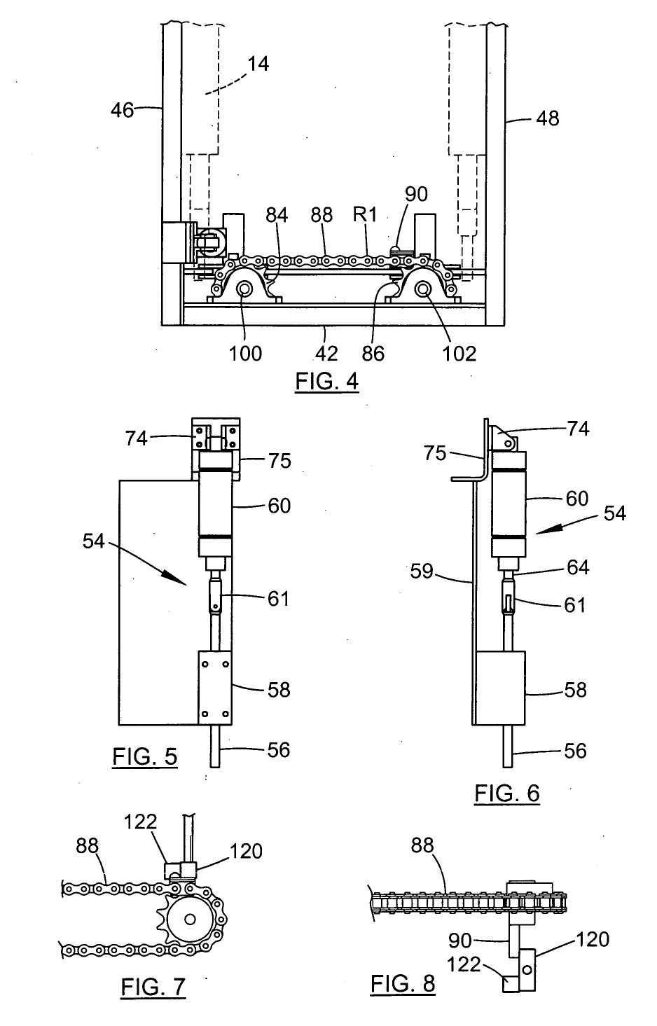

As illustrated, the plate shifting apparatus 10 has two plate shifting assemblies indicated generally at 80 and 82 mounted on the shifter carriage 24 and located on opposite sides of the filter press. It will be understood that although two plate shifting assemblies are used in the illustrated embodiment, it is also possible to construct a plate shifting apparatus having a single plate shifting assembly. For example, it will be appreciated by those skilled in the art that it is possible to construct a plate shifting apparatus with a separate shifter carriage on each side of the filter press, each carriage with its own plate shifting assembly. In such a case, the movement of the two shifter carriages can be coordinated so that they move in the same manner and at the same time in order to shift filter plates horizontally. Also the use of a single plate shifting assembly in a plate shifting apparatus may be possible where the filter plates can easily be shifted horizontally by a single plate shifting assembly due to the nature of the filter press and its construction. It will be understood herein that the two plate shifting assemblies 80, 82 used in the illustrated apparatus are of similar construction and therefore the assembly 82 shown in FIGS. 2 and 3 will only be described in detail herein. Each plate shifting assembly is mounted on the shifter carriage for horizontal movement therewith and each assembly includes first and second sprocket wheels 84, 86 which can be seen in FIG. 4. These sprocket wheels are rotatably mounted on the carriage and are spaced from each other horizontally. They are also aligned with each other in the vertical direction. An endless flexible member 88, which as illustrated comprises an endless drive chain, extends around the two sprocket wheels for movement along first and second horizontal runs indicated in FIG. 4 as R₁ and R₂. A shifter pin 90 is mounted on the drive chain for movement therewith. The shifter pin is mounted on the outside of the chain as can be seen in FIG. 4. Another section of the shifter pin can be cut away to provide a flat side to which can be connected chain attachments 92, 94 shown in FIG. 1. These chain attachments are used to connect the pin to the drive chain and they keep the shifter pin upright and secure. A drive roller chain provided with suitable attachments is available from Tsubaki under the trade name RS attachment chain. Also as can be seen in FIG. 1, each shifter pin is arranged and located so as to be capable of engaging a horizontally projecting handle bar 98 which can be considered an extension of the handle 16 of each filter plate. The sprocket wheels 84, 86 are mounted on respective vertical shafts 100, 102. As shown, the shaft 100 is much longer than the shaft 102 and extends upwardly to and is connected to a respective gear set 104, 106. Each of these shafts is mounted for rotation in a pair of aligned ball bearing units 108, 100. These ball bearing units are bolted to the side of support plate 44. Other types of bearing units for the shafts could also be used.

The illustrated plate shifting apparatus includes a motor drive system connected to one of the shafts of each plate shifting assembly in order to rotate this one shaft and thereby drive the drive chain during operation of the apparatus. The motor drive system as shown includes a single drive motor 112, the aforementioned gear sets 104 and 106 which are right angled gear sets, and an elongate drive shaft 114 that extends between the first gear set 104 and the second gear set 106 so that the first gear set can drive the second gear set. The drive shaft 114 has a length sufficient to extend horizontally and transversely over the filter press 12. The motor 112 can be operatively connected to a drive shaft coupling 116 of standard construction and this coupling is connected to the gear set 104. The motor 112 can be one of several different types including pneumatic, electric and hydraulic. Also the motor 112 in this embodiment is reversible so that not only can the motor drive system be used to shift the filter plates one at a time in order to remove the filter cake, but it can also be used to return the carriage and its plate shifting assemblies to a parked position as explained further hereinafter. In this parked position, the shifter carriage is located between the follower 22 and a standard hydraulic cylinder bracket of the filter press.

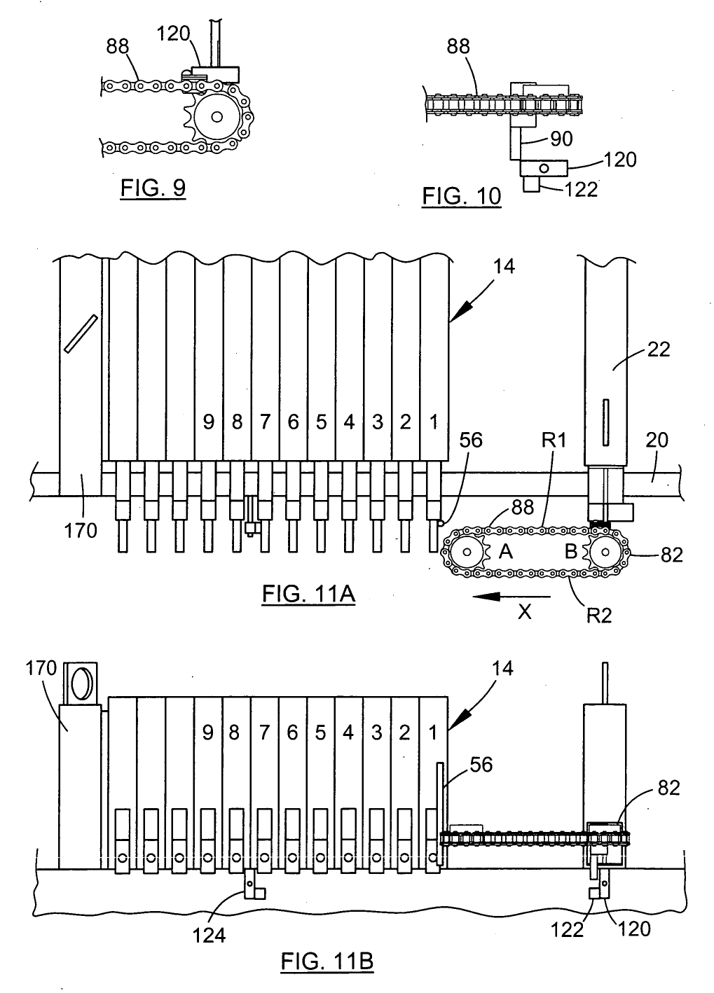

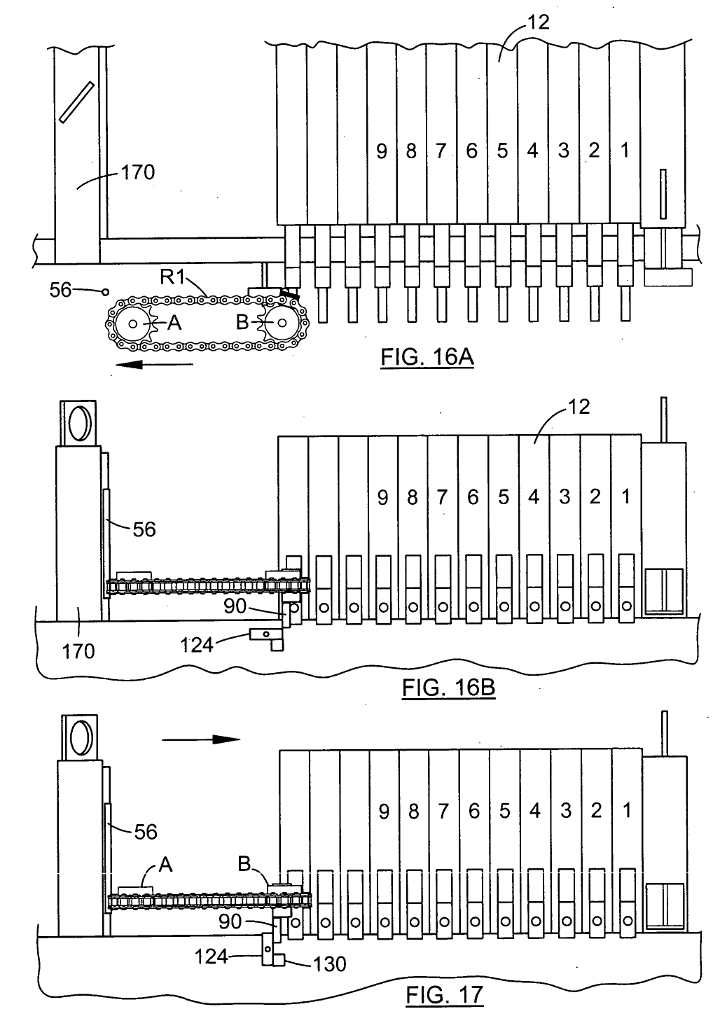

FIGS. 7 to 10 illustrate the operation of pawl mechanisms used with the present plate shifting apparatus. In particular, there is shown in FIGS. 7 and 8 a pivotable drive pawl 120. This drive pawl can pivot between an up position shown in FIG. 8 and a down position shown in FIG. 10. A stop member 122 is located next to the pawl and prevents rotation of the pawl beyond the positions illustrated in FIGS. 8 and 10. The drive pawl 120 is spring loaded (spring not shown) and is biased by the spring to the up position shown in FIG. 8. The pawl is pivotably mounted on a side bar of the filter press in the position shown in FIGS. 11A and 11B and in a manner similar to the return pawl 124 shown in FIG. 16B. Both the drive pawl 120 and the return pawl are pushed to the down position against the spring force when each is engaged by the shifter pin moving in one direction and returns to the up position after the shifter pin has passed by. Each pawl can act as an anchor point to hold the shifter pin when it is moved in the opposite direction.

Sequence of Operation

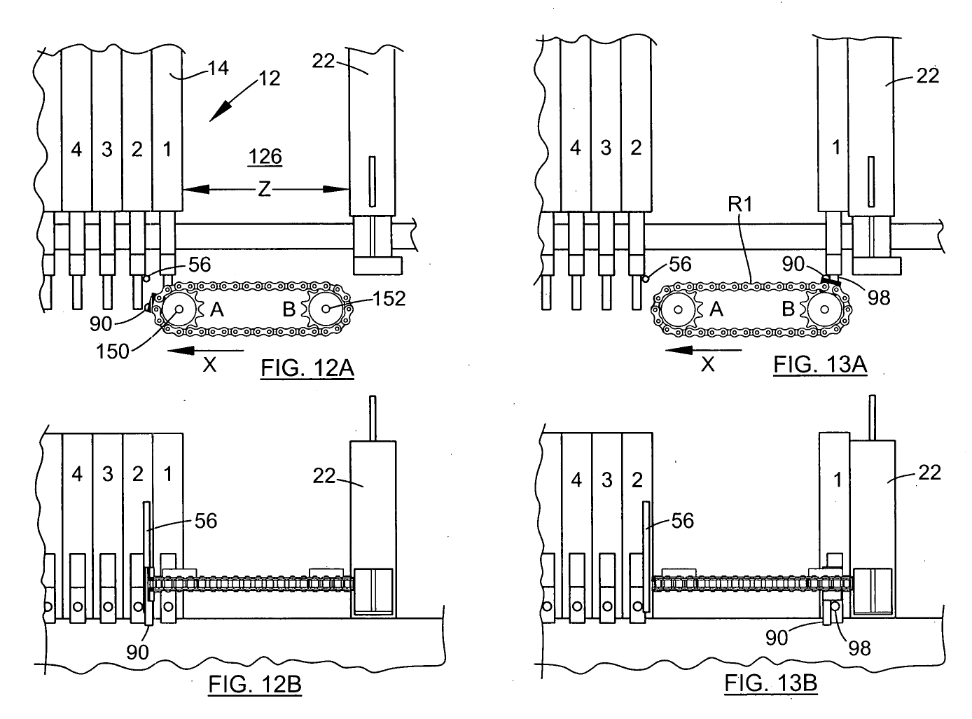

The various steps in the operation of the illustrated embodiment 10 will now be described with particular reference to FIGS. 11A to 21B. Illustrated schematically in FIGS. 11A and 11B are portions of a filter press including portions of the filter plates in a series of movable filter plates 14 and part of the plate shifting apparatus. Although portions of twelve filter plates are illustrated, the number of plates in a given filter press may be any number between (for example) 6 and more than 100. Only one plate shifting assembly 82 is shown in the schematic figures but it will be understood that the opposite plate shifting assembly 80 moves and operates in a similar manner and at the same time. FIGS. 11A and 11B illustrate the plate shifting assembly ready to move into position to collect the first filter plate. In this position, the above described anchor member 56 can be in the down position to prevent the shifter carriage from being moved out of the required position. Alternatively, a spring catch can be used to hold the shifter carriage and the plate shifting assemblies in this position. In order to commence the plate shifting operation, a start button on a control panel (not shown) is pressed in order to turn on the drive motor 112 and operate the motor drive system. The shifter pin 90 is then driven such that the section of the drive chain closest to the filter plates, that is run R₁ in FIG. 4 moves in the direction from the head plate 170 of the filter press to the tail plate, that is the direction from left to right in FIGS. 11A to 11B. The outer run R₂ moves in the direction of the arrow X shown in FIGS. 11A and 12A. This movement of the shifter pin brings it into contact with the drive pawl 120 which is in the up position as shown and which causes the entire shifter carriage including plate shifting assembly 82 to move from a parked position first to the position shown in FIGS. 11A and 11B and then incrementally to the further position shown in FIGS. 12A and 12B for collecting the first filter plate (1) which can be sensed by a first sensor such as a photoelectric or proximity sensor. In this position, the anchor member 56 is extended i.e. moved downwardly so that it extends between the side projections of filter plates 1 and 2, and in particular between the handle bars 98 of plates 1 and 2. The anchor member 56 is moved as a result of the control unit receiving a signal from the first sensor. The signal provided by this sensor can be electrical or pneumatic. The anchor member holds the second of the two plates, that is plate 2 against movement in the horizontal direction. The shifter pin 90 is rotated around the sprocket wheel A into the space between the two side projections of filter plates 1 and 2 and in particularly the space between the handle bars 98 of these plates.

Turning to the step illustrated in FIGS. 13A and 13B, in this step the anchor member remains extended, the shifter pin has been rotated around the sprocket A and brought into engagement with the handle bar 98 of plate 1. The shifter pin is then moved by the drive chain along run R₁ and acts to push plate 1 by means of its side projection to its furthest extent of travel, or, in other words, in the illustrated embodiment to a position adjacent the follower 22. In this position, the shifter pin is at the top of sprocket B as seen in FIG. 13A.

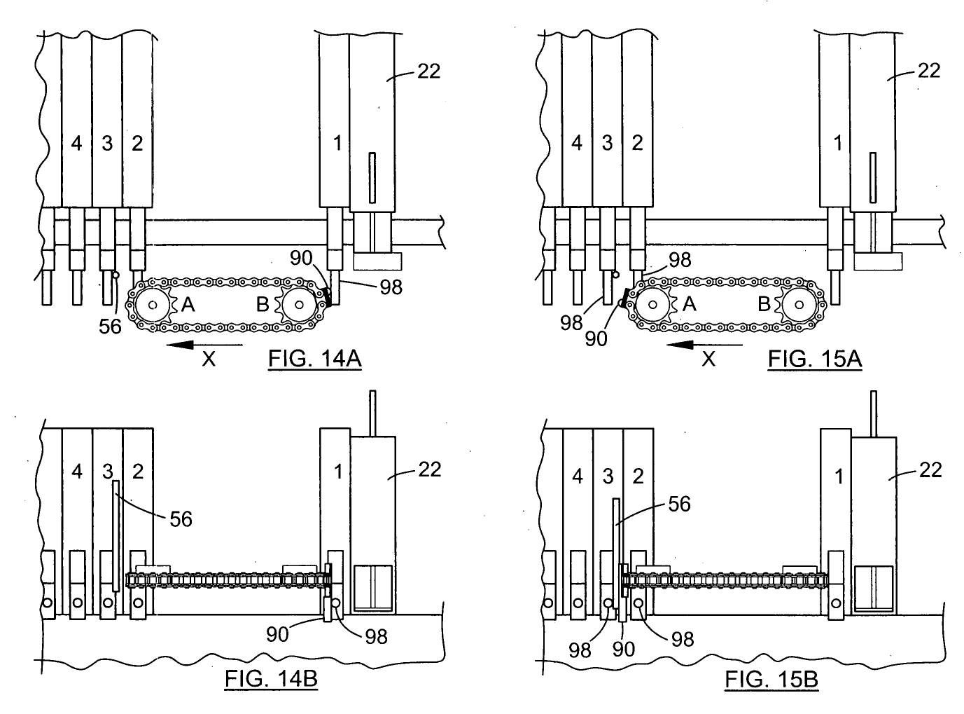

Turning now to the next step in the sequence shown in FIGS. 14A and 14B, at this time, the anchor member 56 can be retracted and this allows horizontal shifting of not only the anchor mechanism but the entire shifter carriage for purposes of the next shifting step. The anchor pin can be retracted by the control unit for the apparatus which will send an electrical or pneumatic signal to an air control valve in order to operate the drive cylinder device 60. At the same time, the shifter pin 90 remains in contact with the handle bar 98 of plate 1 while and until the sprocket wheel B rotates through a one-quarter revolution, i.e. through 90°. Because of the engagement between the shifter pin and the handle bar 98, the shifter carriage is advanced or indexed in the direction of plate 2 by a distance equal to the radius of sprocket B. In one embodiment a second sensor is provided to report to the control unit when the filter plate 1 has been delivered to the cake discharged/stored position shown in FIGS. 13A to 14B. Again the first mentioned sensor can be used to report to the control unit when the plate shifting assembly and its shifter carriage have been moved to the correct location for collecting the filter plate 2. It is this sensor which sends a signal to the control unit to cause the control unit to send a signal to the control valve operating the cylinder device 60 and its anchor member 56 so that the next shifting cycle can commence.

In the shifting step shown in FIGS. 15A and 15B, the shifter pin 90 is rotated and moved along the outside run of the drive chain, and then rotated by the sprocket wheel A past the handle bar 98 of plate 2. During this movement of the shifter pin, the shifter carriage does not move. The shifter pin 90 is rotated between the handle bars 98 of plates 2 and 3 and the shifting process begins again as described above in order to shift plate 2.

When the last filter plate in the series has been shifted, a third sensor can sense that this has occurred and send a signal to the control unit to indicate that the shifter carriage must be returned to the stored or parked position. When the last plate, ie. plate 12 is shifted, the return pawl 124 is knocked down by the pin 90 to a position similar to the drive pawl 120 in FIG. 10. However, the pawl 124 returns to the upright position shown after the pin 90 has passed over it.

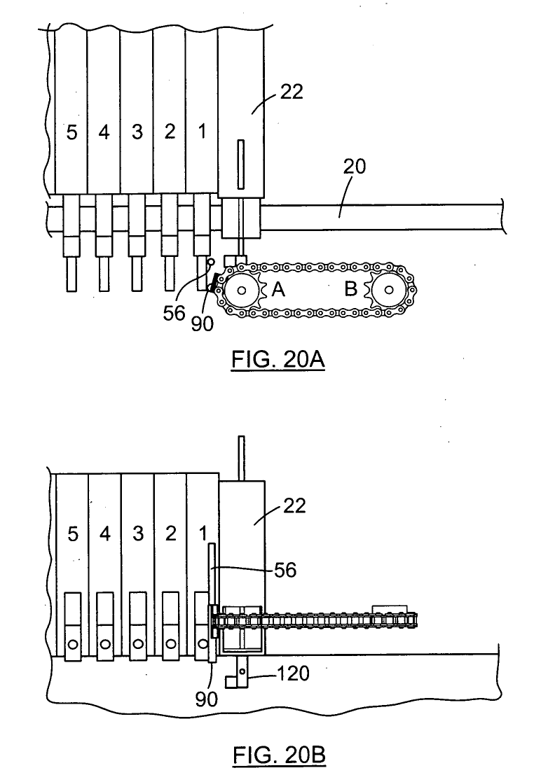

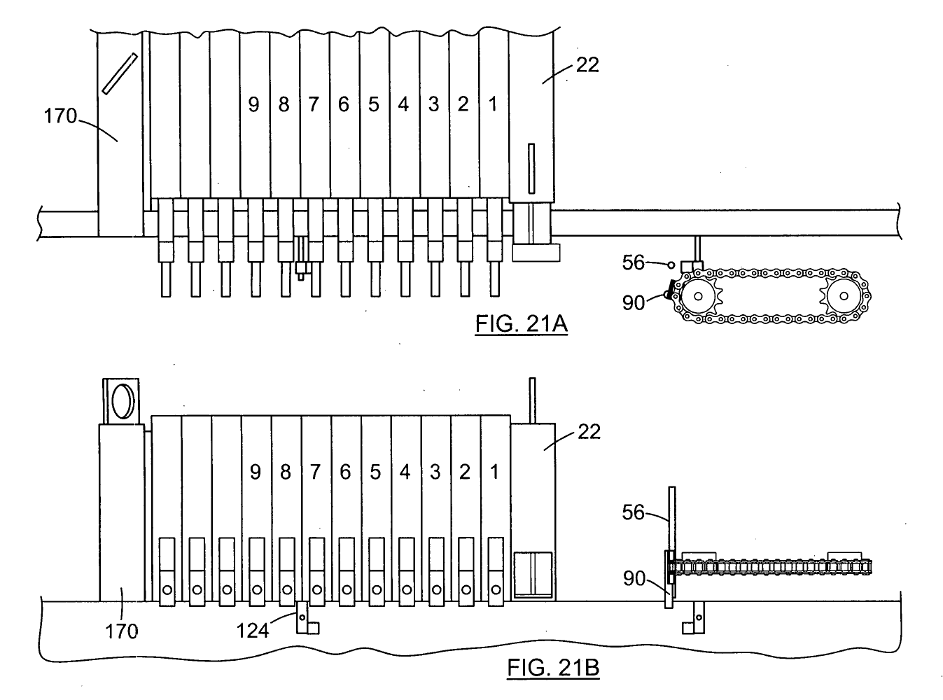

The second sensor can be used to confirm that the last filter plate in the series has in fact been shifted or delivered to the required position (which is the position shown in FIGS. 16A and 16B). A combination of the signals from these two sensors can then cause the control unit to operate the drive motor 112 in the reverse direction and also cause the anchor members 56 to be raised. The shifter pin 90 will now be driven in the direction from the cylinder bracket to the head plate 170 of the press. In other words, the drive chain along the run R₁ moves from sprocket wheel B to sprocket wheel A. As shown in FIG. 17, the shifter pin is brought into engagement with the return pawl 124 which is in the up position where it can act as an anchor and which cannot pivot counter clockwise because of adjacent stop member 130. Accordingly, further rotation of the shifter pin causes the shifter carriage to be moved by one full increment equal to the distance between the centers of sprocket wheels A and B. Once the shifter carriage has advanced this distance, the shifter pin becomes disengaged from the pawl and, in a series of steps is brought into contact with one or more handle bars 98 until the shifter carriage has reached the parked position shown in FIGS. 20A and 20B at which point the motor is signaled to stop. Note that when the shifter pin is moved to engage a first handle bar 98 in the series of steps, the carriage will again be moved one full increment of travel. It will also be appreciated that the returning of the shifter carriage to the parked position is relatively quick. The return of the shifter carriage to the parked position can be determined by another sensor which is able to send a signal to the control unit to switch off the drive motor 112. FIGS. 20A and 20B show the shifter carriage in the parked position with the filter press in the open position after filter cake discharge and cleaning. In FIGS. 21A and 21B the shifter carriage is in the same parked position but the filter press has now been closed, that is, the follower 22 and filter plates have all been shifted by the cylinder of the press to the left as seen in this side view.

It will be appreciated by those skilled in the plate shifting art that the horizontal distance between the axes of rotation of the two sprocket wheels is established by the horizontal distance that each filter plate must be moved during a plate shifting operation. This shifting distance can be seen clearly in FIG. 12A which illustrates the gap 126 through which each filter plate must be shifted. The distance between the vertical axes of rotation 150 and 152 of sprocket wheels A and B is equal to the shifting distance Z which is a predetermined horizontal distance.

It will be understood that the shifter carriage can be moved from the position shown in FIGS. 21A and 21B to the position shown in FIGS. 11A and 11B by rotation of the chain in the direction X and by engagement with the drive pawl 120 (as indicated above). In this way, the entire plate shifting sequence can begin again.

It will be appreciated that there has been described an embodiment of a plate shifting apparatus which is able to move filter press plates from a first position to a second position so as to allow filter cake to be discharged from the filter press. Moreover the described plate shifting apparatus will allow the mounting of auxiliary equipment such as cloth washers and cake scrapers that must normally be coordinated with the movement of the filter plates.

It will be readily apparent to those skilled in this art that various modifications and changes can be made to the described embodiment of a plate shifting apparatus without departing from the spirit and scope of this invention. Accordingly, all such modifications and changes as found within the scope of the intended claims are intended to be part of this invention.

1. A plate shifting apparatus for a filter press having a series of movable filter plates in a horizontal series and having lateral projections on sides of the filter plates, said apparatus comprising:
a shifter carriage;
a track on which said shifter carriage can be mounted for movement in a horizontal direction, said track being adapted for mounting adjacent said filter press;
an anchor mechanism mounted on said shifter carriage and having an anchor member movable between a plate holding position where the anchor member extends between the projections of two of said filter plates in order to hold a second of said two plates against movement in the horizontal direction and a retracted position which permits horizontal shifting of the anchor mechanism during use of said apparatus; and
a plate shifting assembly mounted on said shifter carriage for horizontal movement therewith, said assembly including first and second sprocket wheels rotatably mounted on said carriage and spaced from each other horizontally a predetermined distance corresponding substantially to a desired distance for shifting each filter plate in order to remove filter cake from between adjacent plates and an endless flexible member extending around the two sprocket wheels for movement along first and second horizontal runs; and a shifter pin mounted on said flexible member for movement therewith,
wherein, during use of said apparatus, said shifter pin is movable to a first position where the shifter pin extends between the same two projections as said anchor member, is then engaged with the handle of the first of the two plates, is then moved horizontally together with the first plate along the first run by the flexible member to the first sprocket wheel, and subsequently is returned along the second run to the second sprocket wheel, this sequence of steps being repeatable on the remaining unshifted plates in order to move each of these filter plates towards said first sprocket wheel and up to a location adjacent the immediately preceding filter plate of the series.

2. A plate shifting apparatus according to claim 1 wherein said endless flexible member is an endless drive chain, said sprocket wheels are mounted on respective vertical shafts, and said plate shifting assembly includes a motor drive system connected to one of said shafts for rotating said one shaft and thereby driving said drive chain during operation of the apparatus.

3. A plate shifting apparatus according to claim 2 wherein said anchor member is a vertically extending rod member and said anchor mechanism includes a guide block having a vertical passage for receiving said rod member and a drive cylinder device connected to said rod member for moving said rod member vertically between said plate holding position and said retracted position, said guide block and drive cylinder device being mounted on said shifter carriage.

4. A plate shifting apparatus according to claim 1 wherein said shifter carriage includes two side frame sections adapted for mounting on opposite sides of the filter press and a top frame arrangement rigidly interconnecting said two side frame sections and constructed to extend over said series of filter plates during use of said apparatus, each side frame section having rollers mounted thereon, and wherein said track comprises two rail sections adapted for mounting so as to extend horizontally on opposite sides of said filter press, said rollers on each side frame section being capable of rolling along a respective one of said rail sections during use of the apparatus.

5. A plate shifting apparatus according to claim 2 wherein said sprocket wheels are rotatable about respective vertical axes defined by said vertical shafts, said vertical axes being spaced apart horizontally said predetermined distance, and wherein, during use of said apparatus, each of said filter plates in said series is moved horizontally by the shifter pin by said predetermined distance.

6. A plate shifting apparatus according to claim 2 wherein, during use of said apparatus, said shifter carriage is movable to a parked position on said track where said shifter carriage is located between a follower and a hydraulic cylinder bracket of said filter press and wherein, in order to commence the shifting of said series of plates, said flexible member and shifter pin are moved on said sprocket wheels in a manner which results in said shifter carriage being moved along said track to a collection position where said shifter pin can be moved to said first position.

7. A plate shifting apparatus according to claim 6 including a drive pawl mounted on said filter press for movement between a pin engagement position and a non-engagement position, wherein said shifter pin is brought into engagement with said drive pawl in said pin engagement position in order to move said shifter carriage to the collection position.

8. A plate shifting apparatus according to claim 2 wherein, during use of said apparatus, said plate shifting assembly and shifter pin are adapted to index the shifter carriage and the shifting assembly a predetermined horizontal distance required for shifting the next filter plate in said series by said shifter pin remaining in contact with the projection of the last shifted filter plate through a partial rotation of said first sprocket wheel after said last shifted plate has been shifted a maximum distance on said filter press to a filter cake discharged position.

9. A plate shifting apparatus according to claim 2 wherein said motor drive system is reversible and, when said motor drive system is operated in reverse during use of said apparatus, said shifting assembly and shifter pin can be used to move said shifter carriage and said shifter assembly to a parked position on said track where said shifter carriage is located between a follower and a hydraulic cylinder bracket of said filter press.

10. A plate shifting apparatus for a filter press having a series of movable filter plates in a horizontal series with each filter plate having two projections located on opposite sides of the plate, said apparatus comprising:
a shifter carriage adapted for mounting over said filter press during use of the apparatus, said carriage including two side frame sections for mounting on opposite longitudinal sides of the filter press and a top frame arrangement interconnecting said two side frame sections;
a track on which said shifter carriage can be mounted for horizontal movement in a longitudinal direction relative to the filter press; and
two plate shifting assemblies mounted on said shifter carriage, each assembly including first and second sprocket wheels rotatably mounted on a respective one of said side frame sections and spaced from each other horizontally, an endless flexible member extending around the two sprocket wheels for movement along first and second horizontal runs, and a shifter pin mounted on said flexible member for movement therewith,
wherein, during use of said apparatus, each shifter pin is movable to a first position where the shifter pin extends between two projections of the first and second filter plates in said series, is then engaged with the projection of the first of the two plates, is next moved horizontally together with the first plate along the first run by its respective flexible member to its respective first sprocket wheel, and subsequently is returned along the second run to the second sprocket wheel, this sequence of steps being repeatable on the remaining unshifted filter plates in order to move each of these filter plates towards said first sprocket wheel and up to a location adjacent the immediately preceding filter plate of the series.

11. A plate shifting apparatus according to claim 10 wherein said track comprises two rail sections adapted for mounting so as to extend horizontally on opposite sides of said filter press and each of said side frame sections has rollers mounted thereon which are capable of rolling along a respective one of said rail sections.

12. A plate shifting apparatus according to claim 10 including at least one anchor mechanism mounted on said shifter carriage, the or each anchor mechanism having an anchor member movable between a plate holding position, where the anchor member blocks movement of a second plate in a series of said filter plates which have not been shifted yet by movement of the shifter pins along said first run to the first sprocket wheels, and a retracted position which permits horizontal shifting of the anchor mechanism during use of the apparatus.

13. A plate shifting mechanism according to claim 12 wherein each endless flexible member is a drive chain, said sprocket wheels are mounted on vertical shafts, and said apparatus includes a motor drive system connected to one of said vertical shafts of each plate shifting assembly for rotating said one vertical shaft and thereby driving its respective drive chain during operation of said apparatus.

14. A plate shifting mechanism according to claim 13 wherein said motor drive system includes a single drive motor, first and second right angled gear sets, and an elongate drive shaft extending between said first and second gear sets so that said first gear set can drive said second gear set and having a length sufficient to extend horizontally and transversely over said filter press, and wherein said one vertical shaft of each plate shifting assembly is connected to a respective one of said gear sets.

15. A plate shifting apparatus according to claim 12 wherein there are two of said at least one anchor mechanisms with each anchor mechanism mounted on a respective one of said side frame sections and wherein each anchor member in said plate holding position extends between projections of a leading filter plate and said second filter plate in said series of said filter plates which have not been shifted yet by movement of said shifter pins along said first run.

16. A plate shifting apparatus according to claim 15 wherein said anchor member is a vertically extending rod member and each anchor mechanism includes a guide member having a vertical passage for receiving said rod member and a drive cylinder connected to said rod member for moving said rod member vertically between said plate holding position and said retracted position.

17. A plate shifting apparatus according to claim 13 wherein said sprocket wheels are rotatable about respective vertical axes defined by said vertical shafts, said vertical axes of the sprocket wheels of each plate shifting assembly being spaced apart a horizontal predetermined distance, and wherein, during use of said apparatus, each of said filter plates in said series is moved horizontally by the shifter pins by said predetermined distance corresponding to a desired distance for shifting each filter plate in order to remove filter cake from between adjacent plates.

18. A plate shifting apparatus according to claim 10 wherein, during use of said apparatus, said shifter carriage is movable to a parked position on said track where said shifter carriage is located between a follower and a hydraulic cylinder bracket of said filter press and wherein, in order to commence the shifting of said series of plates, said flexible members and shifter pins are moved on their respective sprocket wheels simultaneously so as to cause said shifter carriage to be moved along said track to a collection position where said shifter pins can both be moved to said first position.

19. A plate shifting apparatus according to claim 18 including two drive pawls each mounted on said filter press for movement between a pin engagement position and a non-engagement position, wherein each shifter pin is brought into engagement with a respective one of said drive pawls in said pin engagement position in order to move said shifter carriage to the collection position.

20. A plate shifting apparatus for a filter press having a series of filter plates in a horizontal series, said filter plates being horizontally movable in a longitudinal direction of the press, said apparatus comprising:
a shifter carriage adapted for horizontal movement in said longitudinal direction; and
a plate shifting assembly mounted on said shifter carriage for movement with said carriage in said longitudinal direction, said plate shifting assembly including a movable endless flexible member, that in use extends horizontally in said longitudinal direction, and a shifter member mounted on said flexible member for movement therewith,
wherein, during use of said apparatus, said shifting assembly can shift each filter plate in said series horizontally from a first filtering position to a second position in order to discharge filter cake from each filter plate, said shifting being carried out sequentially starting with a leading filter plate in said horizontal series, each filter plate being shifted by said shifter member being moved by said flexible member into engagement with the respective filter plate and then being moved along with the filter plate by said flexible member horizontally to said second position.

21. A plate shifting apparatus according to claim 20 including an anchor mechanism mounted on said shifter carriage and having an anchor member movable between a filter plate holding position, where during use of said apparatus the anchor member can engage a second filter plate in a series of unshifted filter plates in order to prevent horizontal movement of the second filter plate with the first filter plate in the longitudinal direction of the press, and a retracted position which permits horizontal shifting of the anchor mechanism.

22. A plate shifting apparatus according to claim 20 wherein said endless flexible member is an endless drive chain and said plate shifting assembly includes first and second sprocket wheels rotatably mounted on said shifter carriage by means of respective vertical shafts defining parallel vertical axes of rotation, said drive chain extending around the two sprocket wheels for movement along two horizontal runs.

23. A plate shifting apparatus according to claim 22 wherein said shifter carriage includes two side frame sections adapted for mounting on opposite sides of the filter press and a top frame arrangement rigidly interconnecting said two side frame sections and constructed to extend over said series of filter plates during use of said apparatus, each side frame section having rollers mounted thereon, and wherein said apparatus further includes a track on which said shifter carriage can be mounted for horizontal movement, said track comprising two rail sections adapted for mounting so as to extend horizontally on opposite sides of said filter press, said rollers on each side frame section being capable of rolling along a respective one of said rail sections during use of the apparatus.

24. A plate shifting apparatus according to claim 20 including a second plate shifting assembly mounted on said shifter carriage for movement with said carriage in the longitudinal direction, said second plate shifting assembly also including a second endless flexible member that in use extends horizontally in said longitudinal direction and a second shifter member mounted on said second flexible member for movement therewith, wherein the two plate shifting assemblies are mounted on opposite sides of the shifter carriage so that, during use of the apparatus, the two plate shifting assemblies are located on opposite longitudinal sides of the filter press.

25. A plate shifting apparatus according to claim 24 including two anchor mechanisms mounted on said shifter carriage and each having an anchor member movable vertically between a filter plate holding position, where during use of the apparatus the two anchor members can engage a second filter plate in a series of filter plates that have not yet been shifted in order to prevent horizontal movement of the second filter plate with a first filter plate in the longitudinal direction of the press, and a retracted position which permits horizontal shifting of the respective anchor mechanism.

26. A plate shifting apparatus according to claim 22 wherein, during use of the apparatus, said plate shifting assembly and the shifter member are adapted to index the shifter carriage and the shifting assembly a predetermined horizontal distance required for shifting the next filter plate in said series by the shifter member remaining in contact with a projection on the last shifted filter plate through a partial rotation of the first sprocket wheel after the last shifted filter plate has been shifted to said second position.

27. A plate shifting apparatus according to claim 22 wherein said plate shifting assembly includes a motor drive system connected to one of said shafts for rotating said shafts and said endless drive chain.

28. A plate shifting apparatus according to claim 27 wherein said apparatus further includes a track on which said shifter carriage can be mounted for said horizontal movement, said motor drive system is reversible, and, when said motor drive system is operated in reverse during use of said apparatus, said shifting assembly and shifter member can be used to move said shifter carriage and said shifter assembly to a parked position on said track where said shifter carriage is located between a follower and a hydraulic cylinder bracket of said filter press.

29. A plate shifting apparatus according to claim 24 including a motor drive system operatively connected to both endless flexible members in order to drive same during use of said apparatus and wherein each endless flexible member is an endless drive chain, each plate shifting assembly further includes first and second sprocket wheels mounted on vertical shafts which are rotatably mounted on said shifter carriage, and each drive chain extends around its respective first and second sprocket wheels for movement along two horizontal runs.

30. A plate shifting apparatus according to claim 29 wherein said motor drive system includes a single drive motor, first and second right angled gear sets, and an elongate drive shaft extending between said first and second gear sets so that said first gear set can drive said second gear set and having a length sufficient to extend horizontally and transversely over said filter press, and wherein one of said vertical shafts of each plate shifting assembly is connected to a respective one of said gear sets.
